(19) United States
(12) Patent Application Publication
(10) Pub. No.: US 2018/0038540 A1
(43) Pub. Date: Feb. 8, 2018

(54) METHOD FOR CONNECTION OF PLASTIC FITTINGS IN A COOLANT VALVE SYSTEM

(71) Applicant: Schaeffler Technologies AG & Co. KG, Herzogenaurach (DE)

(72) Inventor: Vigel Russalian, Macomb, MI (US)

(73) Assignee: Schaeffler Technologies AG & Co. KG, Herzogenaurach (DE)

(21) Appl. No.: 15/230,753

(22) Filed: Aug. 8, 2016

(51) Int. Cl. F16L 55/07; B29C 65/00; B29C 65/48

(52) U.S. Cl. CPC F16L 55/07; B29C 65/4845; B29C 66/5221; B29C 65/4835; B29K 2081/04

(57) ABSTRACT

A method for connection of fittings together as well as a fitting connection are provided. The fitting connection includes first and second fitting parts. The first fitting part has an external circumferential groove, and the second fitting part has at least one circumferential slot located in the wall aligned with the external circumferential groove in an assembled position of the first and second fitting parts. At least one flow hole extends from a sealing space defined between the external circumferential groove and the at least one circumferential slot to an exterior of at least one of the first fitting part or the second fitting part. A curable liquid material is injected through the flow hole into the sealing space defined between the external circumferential groove and the slot. Once cured, the liquid material forms a sealed, form-locked connection between the first and second fitting parts.

### FIELD OF INVENTION

The present invention relates to a method of connecting plastic fittings together, and more particularly to thermal management valve modules used to direct coolant flows in motor vehicles, and particularly to vibration and leak-proof locking connections of plastic fittings used to couple the coolant flow lines to the valve body.

### BACKGROUND

In automotive applications, there is a continued effort toward achieving energy efficiency. In connection with this effort, thermal management valve modules for controlling coolant flows are now being used more commonly in connection with motor vehicles in order to quickly reach and maintain optimum operating temperatures. One such thermal management valve module developed by the assignee of the present invention is disclosed in US2015/0027572, which is incorporated herein by reference as if fully set forth. This thermal management valve module has a plastic housing with multiple inlet and outlet connections that must be connected to plastic fittings that lead to and from the various coolant flow lines in the engine compartment of a motor vehicle, such as to and from the radiator, the vehicle passenger compartment heat exchanger, a battery pack, and/or the engine block cooling circuit. In the engine compartment, installation space is limited, and the connections must be able to provide a long term, reliable, leak-free connection in an exposed environment that is subject to high heat and vibration from the engine as well as corrosive external conditions.

One known prior art connection is shown in FIG. 1. Here the hose fitting 2 is connected to the housing 3 using a screw 4 or other threaded fastener, with an O-ring 5 contacting a gland 6 on the hose fitting 2 providing a seal. This design is less flexible, requires good tolerance control of the seal surfaces as well as more installation space for access to the screws, and has a high assembly cost. Further it is more prone to failure under the vibration and other conditions in a vehicle engine compartment.

It would be desirable to provide a simple solution for sealing and locking plastic fittings used in this and various other applications together in a secure and leak-proof manner with reduced cost and reduced installation space requirements.

### SUMMARY

Briefly stated, a method for connection of fittings together is provided The method includes: (1) providing a first fitting part with an insertion end having an external circumferential groove, and a second fitting part with a wall defining an opening for receiving the insertion end of the first fitting part, the second fitting part including at least one circumferential slot located in the wall and facing the opening that is aligned with the external circumferential groove in an assembled position of the first and second fitting parts, and at least one flow hole that extends from a sealing space defined between the external circumferential groove and the at least one circumferential slot to an exterior of at least one of the first fitting part or the second fitting part; (2) inserting the insertion end of the first fitting part into the opening in the second fitting part to the assembled position; (3) injecting a curable liquid material through the at least one flow hole into the sealing space defined between the external circumferential groove of the first fitting part and the at least one slot in the second fitting part; and (4) curing the liquid material to form a sealed, form-locked connection between the first and second fitting parts.

In another aspect, the first fitting part has an annular cap that contacts a top of the wall of the second fitting part and acts as an outer barrier for the curable liquid material. Further, the insertion end of the first fitting part preferably has a clearance 0.08 inches or less with the opening in the assembled position to form an inner barrier for the curable liquid material.

In another aspect, a plurality of the flow holes are located on at least one of the first fitting part or the second fitting part spaced apart from one another about a periphery, and the method further comprises injecting the curable liquid material into each of the flow holes.

In another aspect, the method further includes engaging a filling nozzle with an outer opening of the at least one flow hole. Preferably, an inspection hole is also provided and can be located on the second fitting part spaced apart from the at least one flow hole. Here, the curable liquid material is injected until it flows out of the inspection hole, providing visual confirmation that the connection area is properly filled.

In one embodiment, the at least one slot comprises a plurality of circumferentially spaced apart slots. Alternatively, a single continuous slot can be provided.

In a preferred arrangement, the fittings are plastic and are part of a thermal management valve module used in connection with a motor vehicle.

Preferably, the curable liquid material is a resin or a polymer such as PPS, visible light/UV cure adhesives, or high temperature RTV.

In another aspect, a fitting connection for a thermal management valve module is provided and includes a first fitting part with an insertion end having an external circumferential groove, and a second fitting part with a wall defining an opening for receiving the insertion end of the first fitting part. The second fitting part includes at least one circumferential slot located in the wall and facing the opening that is aligned with the external circumferential groove in an assembled position of the first and second fitting parts. At least one flow hole extends from a sealing space defined between the external circumferential groove and the at least one circumferential slot to an exterior of at least one of the first fitting part or the second fitting part. A cured liquid material is located in and fills the at least one flow hole and the sealing space defined between the external circumferential groove of the first fitting part and the at least one slot in the second fitting part to form a sealed, form-locked connection between the first and second fitting parts.

Other aspects of the connection as discussed above are also useable in connection with the fitting connection for a thermal management valve module in order to provide a simple and secure fitting connection. The various aspects of the invention discussed herein can be used individually or in various combinations.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is cross-sectional view of a fitting connection in accordance with the known prior art.

FIG. 2 is a detailed view of a first fitting part in accordance with an embodiment of the present fitting connection.

FIG. 3A is a cross-sectional view of a first configuration of a second fitting part used with the present fitting connection.

FIG. 3B is a cross-sectional view similar to FIG. 3A of a second configuration of a second fitting part used with the present fitting connection.

FIG. 4 is a cross-sectional view showing the present fitting connection with the first and second parts in the assembled position with an injectable curable liquid material connecting and sealing the first and second fitting parts together to form the fitting connection.

FIG. 5A is a cross-sectional view of a further configuration of a second fitting part used with another embodiment of the present fitting connection.

FIG. 5B is a cross-sectional view similar to FIG. 5A of an additional configuration of a second fitting part used with the present fitting connection.

FIG. 6 is a cross-sectional view showing another embodiment of a fitting connection with the first and second parts in the assembled position with an injectable curable liquid material connecting and sealing the first and second fitting parts together to form the fitting connection.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

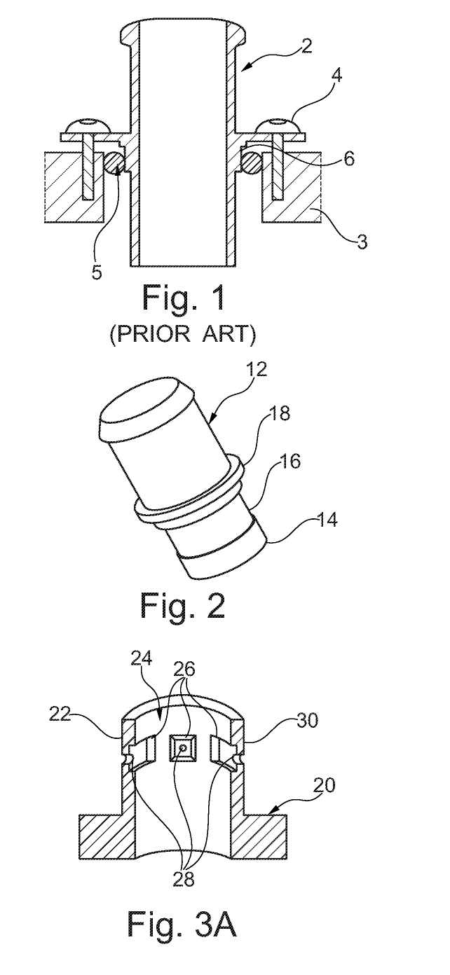

Referring now to FIGS. 2, 3A, 3B, and 4, a method for connection of two fittings together, preferably a first fitting part 12 and a second fitting part 20 for a thermal management valve module, will be explained in detail. FIG. 2 shows the first fitting part 12 with an insertion end 14 having an external circumferential groove 16. Preferably, the first fitting part 12 has an annular cap 18 that contacts a top wall of the second fitting part 20 as shown in FIG. 4 in the assembled position of the first and second fitting parts 12, 20.

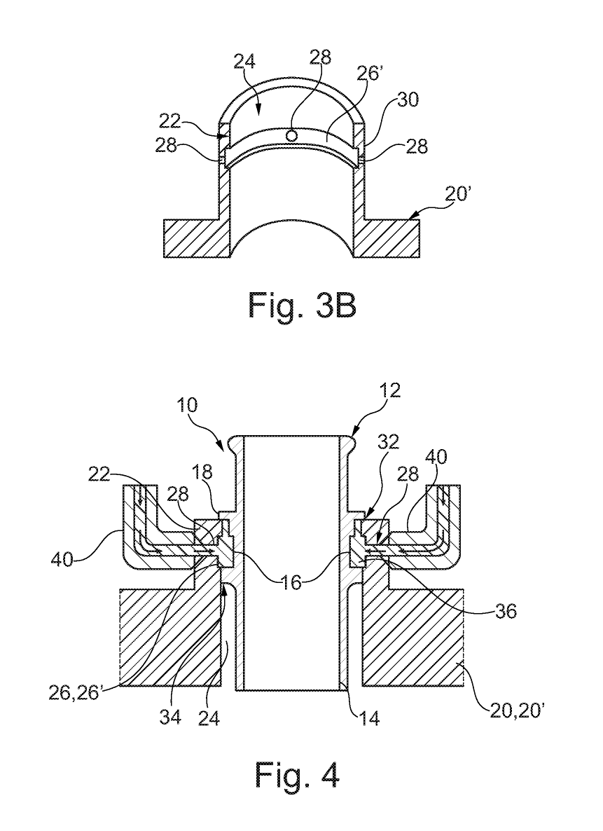

FIG. 3A shows a first configuration of a second fitting part 20 having a wall 22 defining an opening 24 for receiving the insertion end 14 of the first fitting part 12. The second fitting part 20 includes at least one circumferential slot 26 in the wall 22 that faces the opening 24 and is aligned with the external circumferential groove 16 in the assembled position of the first and second fitting parts 12, 20 as shown in FIG. 4. At least one flow hole 28 extends from the at least one circumferential slot 26 to an exterior 30 of the second fitting part 20, as shown in FIG. 3A. In the configuration of FIG. 3A, the second fitting part includes four circumferentially spaced apart slots 26. However, this number could be varied. Each of the slots 26 preferably includes its own flow hole 28.

FIG. 3B shows a second configuration of the second fitting part 20′. The second configuration of the second fitting part 20′ is similar to the previously discussed arrangement of the second fitting part 20 except that a single continuously extending circumferential slot 26′ is located in the wall 22 and preferably includes a plurality of the flow holes 28 that are circumferentially spaced apart, as well as at least one inspection hole 38 that is located in the slot 26′ of the second fitting part 20′ spaced apart from the at least one flow hole 28.

According to the method, the insertion end 14 and the first fitting part 12 is inserted into the opening 24 of the second fitting part 20, 20′ to the assembled position as shown in FIG. 4. Preferably, the annular cap 18 of the first fitting part 12 contacts a top of the wall 24 of the second fitting part and acts as an outer barrier 32 for the curable liquid material to be injected. Additionally, the insertion end 14 of the first fitting part preferably has a clearance of 0.08 inches or less with the opening 24 in the assembled position to form an inner barrier 34 for the curable liquid material to be injected.

As shown in FIG. 4, the curable liquid material 36 is injected through the at least one flow hole 28 into a space defined between the external circumferential groove 16 of the first fitting part 12 and the at least one slot 26, 26′ in the second fitting part 20, 20′. This is preferably accomplished by engaging a filling nozzle 40 with an outer opening of the at least one flow hole 28. As shown in FIG. 4, a plurality of nozzles 40 can be provided that can be connected to some or all of the flow holes 28. The curable liquid material can be injected into each of the flow holes via these filling nozzles 40. However, as shown in connection with FIG. 3B, an inspection hole 38 can also be provided on the second fitting part 20′ that is spaced apart from the at least one flow hole 28 and the curable liquid material 36 can be injected until it flows out of the inspection hole 38. As shown in FIG. 4, the curable liquid material 36 cures to form a sealed, formed locked connection between the first and second fitting parts 12, 20.

The curable liquid material 36 is preferably a resin or a polymer and is injectable in liquid form and fully fills the space formed by the circumferential groove 16 and the single continuous circumferential slot 26′, as shown in connection with the second fitting part 20′ in FIG. 3B, or the plurality of the circumferentially spaced apart slots 26 in the second fitting part 20 as illustrated in FIG. 3A. Various resins or polymers such as PPS, visible light/UV cure adhesives, and high temperature RTV sealing materials can be used as the curable liquid material 36, and these materials preferably all cure at room temperature. One preferred material that can be used as the curable liquid material 36 is a high temperature RTV (room temperature vulcanizing) silicone.

In another aspect of the invention, a fitting connection 10 for a thermal management valve module is provided, as shown in FIG. 4. Here, the first fitting part 12 as described above is provided. The thermal management valve module includes a wall portion that forms the second fitting part 20, 20′, as described above. The cured liquid material 36 is located in and fills the at least one flow hole 28 and a space defined between the external circumferential groove 16 of the first fitting part 12 and the at least one slot 26 in the second fitting part 20, 20′ to form a sealed, formed-locked connection between the first and second fitting parts 10, 20, 20′. This fitting connection 10 is both secure against heavy vibration and leak proof. Further, it requires little installation space for assembly and can be made in situ in an engine compartment of a motor vehicle.

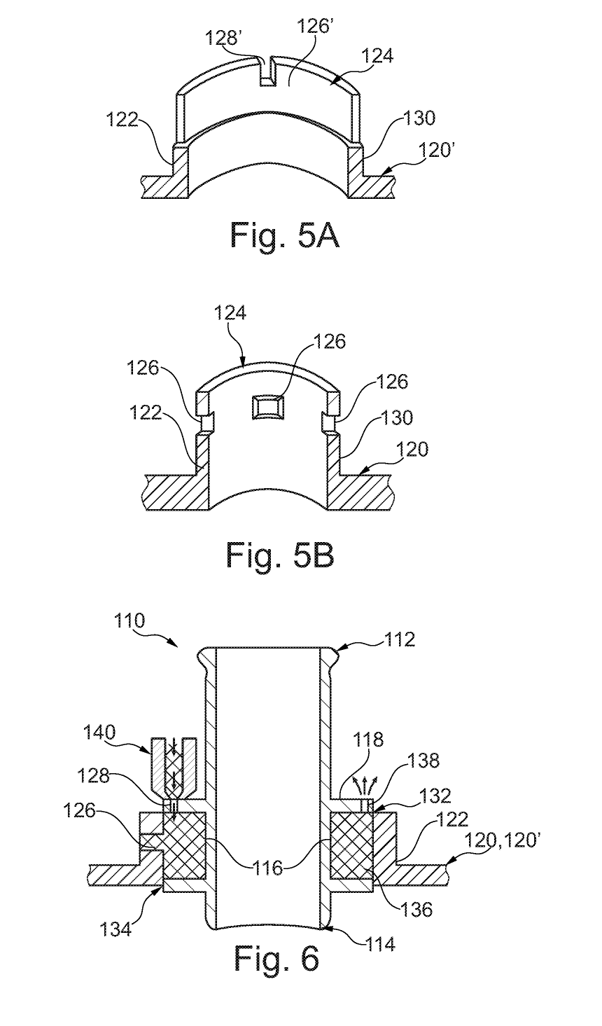

Referring to FIGS. 5A, 5B, and 6, another embodiment of the second fitting part 120, 120′, shown in two different configurations in FIGS. 5A and 5b, having a wall 122, 122′ defining an opening 124 for receiving the insertion end 114 of a second embodiment of the first fitting part 112. The second fitting part 120 is shown with a plurality of circumferentially spaced apart slots 126, while the second fitting part 120′ includes a single continuous circumferential slot 126′. An inspection hole or slot 128′ that extends to an outer surface of the second fitting part can be provided.

As shown in FIG. 6, the second embodiment of the first fitting part 112 is similar to the first fitting part 12 discussed above. It includes an insertion end 114 having an external circumferential groove 116. Preferably, the first fitting part 112 has an annular cap 118 which includes at least one flow hole 128 and can optionally include at least one inspection hole 138. The annular cap 118 of the first fitting part 112 contacts a top of the wall 124 of the second fitting part and acts as an outer barrier 132 for the curable liquid material 136 that is injected. Additionally, the insertion end 114 of the first fitting part preferably has a clearance of 0.08 inches or less with the opening 124 in the assembled position to form an inner barrier 134 for the curable liquid material to be injected.

Another embodiment of a fitting connection 110 for a thermal management valve module is provided, as shown in FIG. 6. Here, the first fitting part 112 as described above is provided. The thermal management valve module includes a wall portion that forms the second fitting part 120, 120′, as described above. The cured liquid material 136 is located in and fills the at least one flow hole 128 and a space defined between the external circumferential groove 116 of the first fitting part 112 and the at least one slot 126 in the second fitting part 120, 120′ to form a sealed, formed-locked connection between the first and second fitting parts 110, 120, 120′. This fitting connection 110 is both secure against heavy vibration and leak proof. Further, it requires little installation space for assembly and can be made in situ in an engine compartment of a motor vehicle.

Those skilled in the art will recognize that various modifications incorporating some or all of the elements of the fitting connections 10, 110 discussed above could be made while still achieving the desired sealed, formed-locked connection.

Fittings installed in this matter on a housing which comprises the second fitting part 20, 20′, 120, 120′ of a thermal management valve module provide a simply installed, highly effective sealing and locking arrangement which can withstand heavy vibration as well as the corrosive environment typical in motor vehicle engine compartments. With the second fitting part 20, 20′, 120, 120′ forming a wall portion of a thermal management valve module, the fitting connection 10 produced according to the invention is highly effective.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

### LIST OF ELEMENT NUMBERS

2 hose fitting
3 housing
4 screw
5 O-ring
6 gland
10 fitting connection
12 first fitting part
14 insertion end
16 external circumferential groove
18 annular cap
20, 20′ second fitting part
22 wall
24 opening
26, 26′ slot(s)
28 flow hole(s)
30 exterior of 2^{nd} fitting part
32 outer barrier
34 inner barrier
36 curable liquid material
38 inspection hole
40 filling nozzle(s)
110 fitting connection
112 first fitting part
114 insertion end
116 external circumferential groove
118 annular cap
120, 120′ second fitting part
122 wall
124 opening
126, 126′ slot(s)
128 flow hole(s)
130 exterior of 2^{nd} fitting part
132 outer barrier
134 inner barrier
136 curable liquid material
138 inspection hole

What is claimed is:

1. A method for connection of fittings together, comprising:
providing a first fitting part with an insertion end having an external circumferential groove, and a second fitting part with a wall defining an opening for receiving the insertion end of the first fitting part, the second fitting part including at least one circumferential slot located in the wall and facing the opening that is aligned with the external circumferential groove in an assembled position of the first and second fitting parts, and at least one flow hole that extends from a sealing space defined between the external circumferential groove and the at least one circumferential slot to an exterior of at least one of the first fitting part or the second fitting part;
inserting the insertion end of the first fitting part into the opening in the second fitting part to the assembled position;
injecting a curable liquid material through the at least one flow hole into the sealing space defined between the external circumferential groove of the first fitting part and the at least one slot in the second fitting part; and
curing the liquid material to form a sealed, form-locked connection between the first and second fitting parts.

2. The method of claim 1, wherein the first fitting part has an annular cap that contacts a top of the wall of the second fitting part and acts as an outer barrier for the curable liquid material.

3. The method of claim 1, wherein the insertion end of the first fitting part has a clearance of 0.08 inches or less with the opening in the assembled position to form an inner barrier for the curable liquid material.

4. The method of claim 1, wherein a plurality of the flow holes are located on at least one of the first fitting part or the second fitting part spaced apart from one another about a periphery, and the method further comprises injecting the curable liquid material into each of the flow holes.

5. The method of claim 1, further comprising engaging a filling nozzle with an outer opening of the at least one flow hole.

6. The method of claim 1, further comprising providing an inspection hole on at least one of the first fitting part or the second fitting part spaced apart from the at least one flow hole, and injecting the curable liquid material until it flows out of the inspection hole.

7. The method of claim 1, wherein the at least one slot comprises a plurality of circumferentially spaced apart slots.

8. The method of claim 1, wherein the fittings are plastic.

9. The method of claim 1, wherein the curable liquid material is a resin.

10. The method of claim 1, wherein the curable liquid material is a polymer.

11. The method of claim 1, wherein the curable liquid material is PPS, a visible light or UV cure adhesives, or a high temperature RTV silicone.

12. A fitting connection for a thermal management valve module produced in accordance with claim 1.

13. A fitting connection for a thermal management valve module, comprising:
a first fitting part with an insertion end having an external circumferential groove;
a second fitting part with a wall defining an opening for receiving the insertion end of the first fitting part, the second fitting part including at least one circumferential slot located in the wall and facing the opening, the at least one circumferential slot is aligned with the external circumferential groove in an assembled position of the first and second fitting parts, and at least one flow hole that extends from a sealing space defined between the external circumferential groove and the at least one circumferential slot to an exterior of at least one of the first fitting part or the second fitting part; and
a cured liquid material located in and filling the at least one flow hole and the sealing space defined between the external circumferential groove of the first fitting part and the at least one slot in the second fitting part to form a sealed, form-locked connection between the first and second fitting parts.

14. The fitting connection of claim 13, wherein the first fitting part has an annular cap that contacts a top of the wall of the second fitting part and acts as an outer barrier for the cured liquid material.

15. The fitting connection of claim 13, wherein the insertion end of the first fitting part has a clearance of 0.08 inches or less with the opening in the assembled position to form an inner barrier for the cured liquid material.

16. The fitting connection of claim 13, wherein a plurality of the flow holes are located on at least one of the first fitting part or the second fitting part spaced apart from one another about a periphery, and the cured liquid material is located in the flow holes.

17. The fitting connection of claim 13, wherein the at least one slot comprises a plurality of circumferentially spaced apart slots.

18. The fitting connection of claim 13, wherein the fittings are plastic.

19. The fitting connection of claim 13, wherein the cured liquid material is a resin.

20. The fitting connection of claim 13, wherein the cured liquid material is a polymer.
